(19) United States
(12) Patent Application Publication
(10) Pub. No.: US 2013/0042719 A1
(43) Pub. Date: Feb. 21, 2013

(54) Multi-Level Handlebars Stem

(71) Applicant: Josef Tuma, Hermosa Beach, CA (US)

(72) Inventor: Josef Tuma, Hermosa Beach, CA (US)

(21) Appl. No.: 13/586,490

(22) Filed: Aug. 15, 2012

Related U.S. Application Data
(60) Provisional application No. 61/575,156, filed on Aug. 15, 2011.

(51) Int. Cl. B62K 21/16

(52) U.S. Cl. 74/551.3

(57) ABSTRACT

A Multi-Level Handlebars Stem device for bicycles or stationary bicycles or other vehicles comprising a steerer bracket, such steerer bracket connecting to a steerer tube or stem adaptor, wherein the steerer bracket is connected to an upper bar and a lower bar at their first ends with through pins, wherein the upper and lower are connected to a handlebar clamp at their second ends by through pins, whereby a lock pin housed in the lower bar engages a notched wheel of the steerer bracket allowing the upper and lower bars to rotate with respect to the steerer tube or stem adaptor.

### CROSS-REFERENCE TO RELATED APPLICATIONS

The present application claims priority under 35 USC 119 (a) (1) from U.S. Provisional Patent Application Ser. No. 61/575,156 filed Aug. 15, 2011 of common inventorship, entitled “Multi-Level Handlebars Stem”.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention pertains to the field of sporting goods, and more specifically to the field of bicycle aftermarket accessories, and even more specifically to the field of handlebar adjustment devices.

### BACKGROUND OF THE INVENTION

The bicycle steerer or stem adapter is a hollow tube with a wedge or cone shaped expander at its bottom end. Historically, once the stem is positioned at the height the cyclist chooses, the expander nut is tightened by a long bolt, the head of which is above the stem. The cyclist can raise or lower the handlebars in degrees but only by stepping and using a wrench which is a time consuming and tedious process. Having a range of adjustment for handlebars is ideal, as the cyclist wants different postures for speed riding, relaxed riding or cruising. A need exists for an improvement in the conventional method by which a bicycle's stern locks into a head tube and holds handlebars in a centered clamp. The prior art has put forth several designs for adjustable bicycle handlebars.

U.S. Pat. No. 4,390,300 to Edwin E. Foster describes a handlebar carrying stem in which the stem is vertically movable within the front fork tube of a bicycle. Internally, this stem pivotally mounts a lever carrying a latching pin that is received within a selected opening in a stationary element within the tube. A pull link having an external control knob on the stem is secured to the lever for controlling movement of the lever.

U.S. Pat. No. 4,384,497 to Stephen L. Gatsos describes an adjustable handlebar means that provides handle grips adapted for movement with respect to the bicycle. At least a pair of unidirectional clutch means control movement of handlebar means. One clutch means permits infinitely variable movement of the handle grips in one direction. The other clutch means permits infinitely variable movement of the handle grips in the other direction. The handlebar means and clutch means are interconnected to prevent movement in two opposite directions and to hold the handle grips immovable in the absence of operation of the clutches.

U.S. Pat. No. 2,438,657 to Marie-Marguerite Dufaux describes an improved bicycle handle which permits the cyclist to change and secure the height of the grip while running.

None of these prior art references describe the present invention.

### SUMMARY OF THE INVENTION

It is an object of the present invention to provide an adjustable handlebar support for bicycles or other vehicles such that the position of the handlebars can be changed without the use of a tool and while the cyclist remains in motion. The present invention handlebar support is specialty designed so hat the adjustment can be made without stopping.

### BRIEF DESCRIPTION OF THE DRAWINGS

FIG. 1 is a drawing of the present invention.

FIG. 2 is a perspective view of the present invention with the handlebars in a low, mid or high position.

### DETAILED DESCRIPTION OF THE INVENTION

The present invention, hereinafter referred to as the Multi-level Handlebars Stem, allows cyclists or other vehicle operators to alter the position of their handlebars through a full range of adjustment without the need for tools.

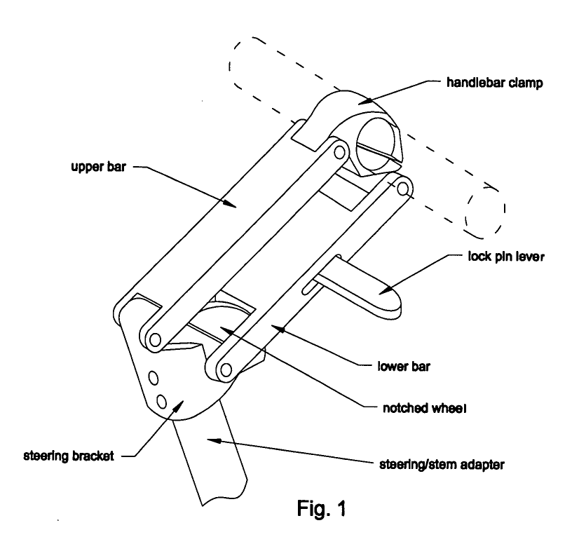

The Multi-Level Handlebars Stem constitutes an improvement over conventional handlebar stems in which height adjustments are limited and possible only with the use of a wrench. As shown in FIG. 1, the Multilevel Handlebars Stem fastens to a bicycle's steerer tube or stem adapter and provides several adjustable height settings with simple manual adjustment. For initial assembly, the present invention is installed by tightening the steerer bracket [1], to the head of the steerer or stem adapter [2] of the bike. Commonly used bike stems angle forward from the bead tube and end in a circular clamp which holds the handlebars, whereas the present invention, the Multi-Level Handlebars steerer bracket [1] supports a cantilever mechanism forming a parallelogram comprised of stainless steel and aluminum or other appropriate materials. This mechanism offers a pivot based range of motion through which the handlebar clamp, which holds the handlebars, may be lowered, raised and locked into alternative positions. The vertical axis of the handlebar clamp [7] and steerer bracket [1] remain parallel through the entire range of motion thus allowing brake handles and shifters to remain in the same position towards the body of the rider. This device fits directly onto the steerer tube on bicycles having a thread less stem or through the stem adapter on bicycles with quill stem systems. For initial installation the steerer bracket [1] is clamped to the steerer or stem adapter [2] using two Allen screws.

The steerer bracket [1] supports two rectangular bars, an upper bar [3] and a lower bar [4]. These bars are approximately five inches in length. Each lower and upper bar mounts on the steerer bracket [1] by means of an axle through pin [5], providing an up or down pivot. The through pins [5] offset with respect to the steerer or stem adapter thus staggering the upper and lower bars. The upper and lower bars remain parallel to one another as the assembly is raised or lowered. Two more through pins [6] support a handlebar clamp [7] at the other end of the bars. The bottom bar attaches to the steerer bracket through a pin that forms the center axis of the semicircular notched locking wheel [8]. The bottom bar also incorporates a spring loaded sliding look pin oriented along the long axis of the lower bar operated by lock pin lever [8]. The lock pin engages the notches in the lock wheel and locks the handle bar assembly into position at any of several heights.

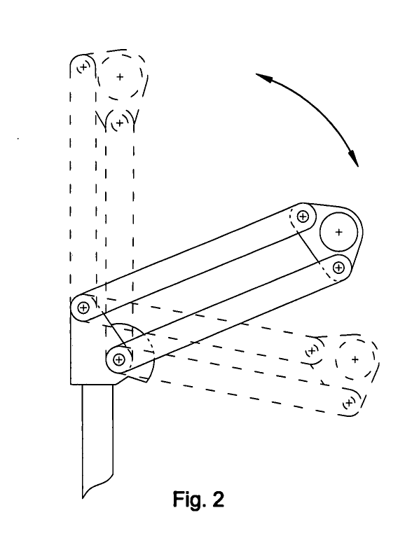

As shown in FIG. 2, in the lowest position [10], the handlebar clamp is roughly level with the top of the stem. In the highest position [11], the handlebar clamp extends directly above the stem top, to a height of approximately six inches. An intermediate position [12] allows the handlebar clamp to be fixed at various points within the full range of adjustment. Adjustment is accomplished by releasing the lock pin, lifting or lowering the handlebars, and then relocking the lock pin.

Because adjustments are made easily, the cyclist may adjust the handlebar position according to their mode of riding. A lower positioned handlebar enables a bent posture for speed riding. A mid-level positioned handlebar enables a more upright posture for relaxed riding. A high positioned handlebar provides the most relaxed cruising posture. This invention replaces several different stems of fixed angle with one self contained adjustable system.

The invention is comprised of components made from stainless steel, aluminum, or other appropriate materials. Individual components may be coated to improve durability, performance or appearance.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

I claim:

1. A device composing a steerer bracket, such steerer bracket connecting to a steerer tube or stem adaptor wherein the steerer bracket is connected to an upper bar and a lower bar at their first ends such that the upper and lower bars may pivot, wherein the upper and lower are connected to a handlebar clamp at their second ends, whereby a locking mechanism housed in the lower bar engages a notched wheel of the steerer bracket allowing the upper and lower bars to rotate with respect to the steerer tube or stem adaptor.

2. A device comprising a steerer bracket, such steerer bracket connecting to a steerer tube or stem adaptor, wherein the steerer bracket is connected to an upper bar and a lower bar at their first ends with through pins, wherein the upper and lower are connected to a handlebar clamp at their second ends by through pins, whereby a lock pin operated by a lever housed in the lower bar engages a notched wheel of the steerer bracket allowing the upper and lower bars to rotate with respect to the steerer tube or stem adaptor.
